(19) United States
(12) Patent Application Publication
(10) Pub. No.: US 2004/0123117 A1
(43) Pub. Date: Jun. 24, 2004

(54) Validation for behavior-blocking system

(75) Inventor: Henry W. Berger, Hampton, VA (US)

Correspondence Address: Serge J. Hodgson, Gunnison, McKay & Hodgson, L.L.P., 1900 Garden Road, Suite 220, Monterey, CA, 93940, US

(73) Assignee: Symantec Corporation

(21) Appl. No.: 10/325,580

(22) Filed: Dec. 18, 2002

(51) Int. Cl. H04L 9/32

(52) U.S. Cl. 713/188

(57) ABSTRACT

A method includes detecting a potentially malicious action of a potentially unsafe application on a host computer system; sending an application characteristic of the potentially unsafe application to a server system; and receiving a response from the server system indicating whether the potentially unsafe application is a safe application, an unsafe application or an unknown application. If the potentially unsafe application in an unknown application, the potentially unsafe application is executed in a sandbox on the server system.

### BACKGROUND OF THE INVENTION

1. Field of the Invention

The present invention relates to the protection of computer systems. More particularly, the present invention relates to a behavior-blocking system and method.

2. Description of the Related Art

Sand-boxing is well known to those of skill in the art and is part of many behavior-blocking systems. In sand boxing, a potentially unsafe application was suspended and sent to a sandbox on the host computer system.

The sandbox contained virtual machines for executing the potentially unsafe application and for monitoring the actions of the potentially unsafe application during execution. By observing these actions, a determination was made as to whether the potentially unsafe application contained malicious code, i.e., whether the potentially unsafe application was in fact safe or unsafe, based upon a set of defined rules.

Ideally, the potentially unsafe application was executed in the sandbox and isolated from the remainder of the host computer system. However, if the potentially unsafe application was in fact unsafe and was not entirely contained in the sandbox, the unsafe application could damage the host computer system during execution in the sandbox.

Further, during execution of the potentially unsafe application in the sandbox, the host computer system processor's resources were utilized, which resulted in a performance hit upon the host computer system.

Other uses of a sandbox were to isolate a potentially unsafe application in the sandbox of the host computer system. The potentially unsafe application was left in the sandbox of the host computer system without execution until an administrator examined the potentially unsafe application to determine if the potentially unsafe application was safe or unsafe. However, this required that administrator resources be utilized for each host computer system.

### SUMMARY OF THE INVENTION

In accordance with one embodiment of the present invention, a method includes detecting a potentially malicious action of a potentially unsafe application on a host computer system; sending an application characteristic of the potentially unsafe application to a server system; and receiving a first response from the server system, the first response indicating whether the potentially unsafe application is a safe application, an unsafe application or an unknown application.

Because only the application characteristic from the host computer system and the response from the server system are sent, the load on the network between the host computer system and server system is minimal.

If the first response indicates that the potentially unsafe application is a safe application or an unsafe application, the host computer system resumes or terminates the potentially unsafe application, respective. However, if the first response indicates that the potentially unsafe application is an unknown application, the host computer system sends the potentially unsafe application to the server system.

The server system determines whether the potentially unsafe application is a safe or unsafe application, for example, using a sandbox. The server system sends a second response indicating whether the potentially unsafe application is a safe application or an unsafe application to the host computer system. If the second response indicates that the potentially unsafe application is a safe application or an unsafe application, the host computer system resumes or terminates the potentially unsafe application, respective.

Because the potentially unsafe application is executed in a sandbox on the server system in accordance with one embodiment, the server system resources are used to determine if the potentially unsafe application is a safe application or an unsafe application, not resources of the host computer system. Thus, resources of the host computer system are conserved. This prevents the degradation of the performance of the host computer system, which would otherwise be associated with executing the potentially unsafe application in a sandbox on the host computer system.

Further, because the potentially unsafe application is executed in the sandbox only after a determination is made that the potentially unsafe application is an unknown application, the number of applications transferred over the network and executed in the sandbox is significantly reduced compared to executing all applications in the sandbox. Thus, use of the network and resources of the server system is minimized.

In addition, because the potentially unsafe application is executed in the sandbox on the server system, the host computer system is protected from being damaged by the potentially unsafe application. Further, the potentially unsafe application is determined to be a safe or unsafe application without intervention by the administrator in one embodiment.

Embodiments in accordance with the present invention are best understood by reference to the following detailed description when read in conjunction with the accompanying drawings.

### BRIEF DESCRIPTION OF THE DRAWING

FIG. 1 is a diagram of a client-server system that includes a monitoring and detection application executing on a host computer system and validation and sandbox applications executing on a server system according to one embodiment of the present invention;

FIG. 2 is a flow diagram of a host computer process in accordance with one embodiment of the present invention; and

FIG. 3 is a flow diagram of a validation and sandbox server process in accordance with one embodiment of the present invention.

Common reference numerals are used throughout the drawings and detailed description to indicate like elements.

### DETAILED DESCRIPTION

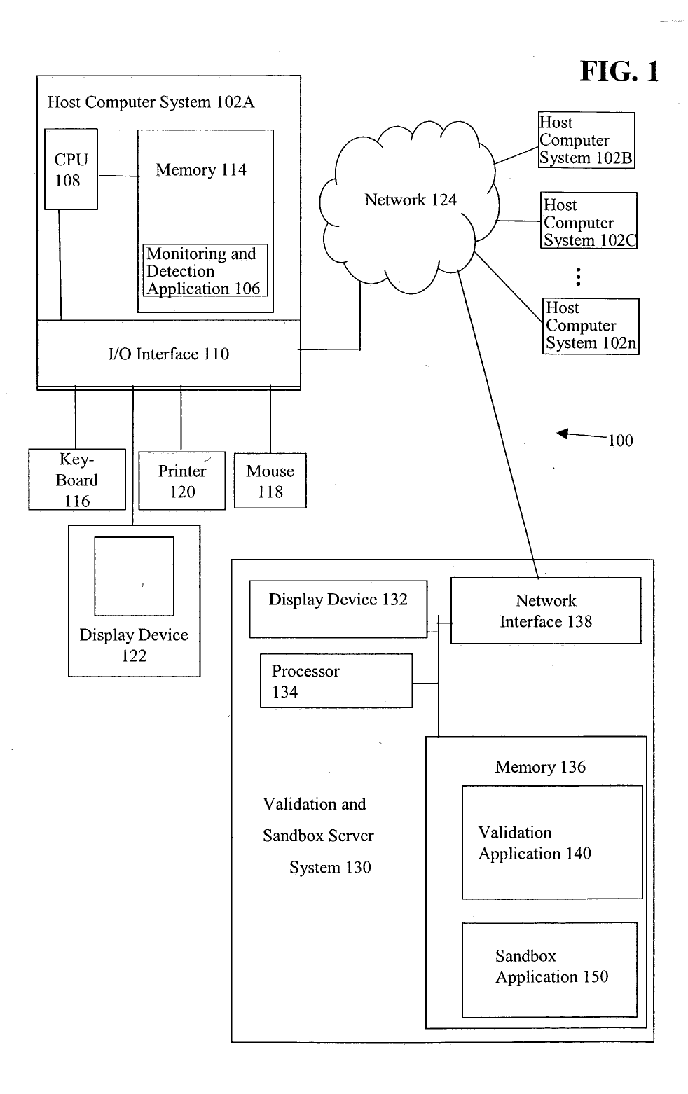

In accordance with one embodiment of the present invention, referring to FIG. 1, a host computer system 102A includes a monitoring and detection application 106 for monitoring and detecting possibly malicious actions of possibly unsafe applications on host computer system 102A. If a possibly malicious action is detected by monitoring and detection application 106, a validation application 140 of a validation and sandbox server system 130 determines whether the possibly unsafe application is a known safe application, a known unsafe application or an unknown application.

If the possibly unsafe application is an unknown application, then a sandbox application 150 determines whether the possibly unsafe application is a safe application or an unsafe application, e.g., using a sandbox.

Because the potentially unsafe application is executed in a sandbox on server system 130 in accordance with one embodiment, server system 130 resources are used to determine if the potentially unsafe application is a safe application or an unsafe application, not resources of host computer system 102A. Thus, resources of host computer system 102A are conserved.

More particularly, FIG. 1 is a diagram of a client-server system 100 that includes a monitoring and detection application 106 executing on a host computer system 102A, e.g., a first computer system, and validation and sandbox applications 140, 150 executing on a validation and sandbox server system 130, e.g., a second computer system, according to one embodiment of the present invention.

Host computer system 102A, sometimes called a client or user device, typically includes a central processing unit (CPU) 108, hereinafter processor 108, an input output (I/O) interface 110, and a memory 114. Host computer system 102A may further include standard input devices like a keyboard 116, a mouse 118, a printer 120, and a display device 122.

Host computer system 102A is coupled to validation and sandbox server system 130, hereinafter server system 130, of client-server system 100 by a network 124. Server system 130 typically includes a display device 132, a processor 134, a memory 136, and a network interface 138.

Generally, at least one host computer system 102A is coupled to server system 130. To illustrate, host computer system 102A is coupled to server system 130 by network 124. However, as illustrated in FIG. 1, a plurality of host computer systems 102B, 102C, . . . , 102n similar to host computer system 102A are coupled to server system 130 by network 124 in accordance with this embodiment of the present invention. For simplicity of discussion, the functionality of and interaction between host computer system 102A and server system 130 are described herein. However, in light of this disclosure, those of skill in the art will understand that the discussion is applicable to host computer systems 102B, 102C, . . . , 102n interacting simultaneously or serially with server system 130.

Network 124 can be any network or network system that is of interest to a user that couples host computer system 102A to server system 130. In various embodiments, network interface 138 and I/O interface 110 include analog modems, digital modems, or a network interface card.

Monitoring and detection application 106 is stored in memory 114 of host computer system 102A and executed on host computer system 102A. The particular type of and configuration of host computer system 102A is not essential to this embodiment of the present invention.

Client-server system 100 further includes validation application 140 executing on server system 130 and sandbox application 150 also executing on server system 130 according to one embodiment of the present invention. The particular type of and configuration of server system 130 is not essential to this embodiment of the present invention.

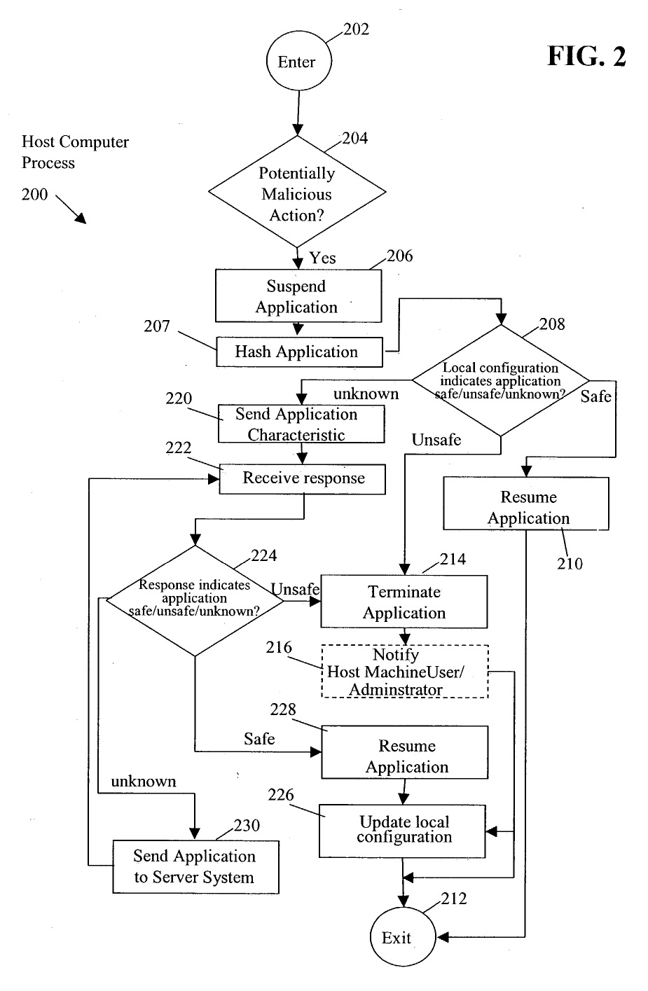

FIG. 2 is a flow diagram of a host computer process 200 in accordance with one embodiment of the present invention. Referring now to FIGS. 1 and 2 together, execution of monitoring and detection application 106 by processor 108 results in the operations of host computer process 200 as described below in one embodiment.

From an enter operation 202, flow moves to a potentially malicious action operation 204. In potentially malicious action operation 204, the actions of the various applications executing on host computer system 102A are monitored and analyzed to determine, sometimes called detect, whether the actions are potentially malicious.

In one embodiment, the actions are monitored and compared to an initial set of rules, e.g., chosen by the administrator or network dependent, to determine if the actions are potentially malicious. Examples of potentially malicious actions include, but are not limited to: (1) an action by an application that accesses the registry, e.g., accesses the run key or run once key so that the application is automatically opened the next time host computer system 102A is booted; (2) an action by an application that opens the application itself, e.g., an application that is mailing itself; (3) an action that opens or alters many files of the same type, e.g., overwrites many bitmap or JPEG files; (4) an action that modifies or deletes system files; (5) an action that opens unauthorized ports; (6) an action that attempts unauthorized communication over an open port; and (7) an action by an application that opens any type of an executable file and modifies the executable file in a known malicious way.

Examples of known malicious modifications of an executable file include: (A) appending the application and/or data to the executable file, for example, in front of (prepending), inside, or after the executable file; and (B) modifying the header of the executable file or otherwise modifying the entry point into the executable file. Further, as used herein, an action is unauthorized if the application that originated the action was not authorized to perform the action.

For purposes of simplicity of discussion, assume an example where the various applications include a potentially unsafe application, sometimes called a first application. The potentially unsafe application may or may not be unsafe, i.e., the safety is unknown. In the discussion that follows, the operations are performed on the potentially unsafe application. However, it is understood that the operations are performed on a plurality, e.g., at least one, of applications simultaneously or serially in accordance with one embodiment of the present invention.

Referring still to potentially malicious action operation 204, the potentially unsafe application has a first action. A determination is made in potentially malicious action operation 204 whether the first action is potentially malicious. If the first action is not potentially malicious, then flow remains at potentially malicious action operation 204. Thus, as long as there are no potentially malicious actions, host computer system 102A does not respond or take any further action.

However, if a determination is made in potentially malicious action operation 204 that the first action is potentially malicious, then flow moves to suspend application operation 206.

In suspend application operation 206, the potentially unsafe application is suspended, i.e., execution of the potentially unsafe application is suspended. This prevents the potentially unsafe application from damaging host computer system 102A in the case when the potentially unsafe application is in fact unsafe, e.g., includes malicious code. In one embodiment, malicious code is defined as any computer program, module, set of modules, or code that enters a computer system without an authorized user's knowledge and/or without an authorized user's consent.

From suspend application operation 206, flow moves to a hash application operation 207. In hash application operation 207, the potentially unsafe application is hashed to generate a hash key. Hash application operation 207 can be performed using any one of a number of well-known hashing techniques, e.g., using an MD5 algorithm, and the particular hashing technique used is not essential to the present invention. Further, in one embodiment, instead of hashing the entire potentially unsafe application, only a portion of the potentially unsafe application is hashed to generate the hash key. In another embodiment, instead of generating a hash key, another unique identifier of the potentially unsafe application is generated or retrieved in hash application operation 207 and used as discussed herein with regards to the hash key.

From hash application operation 207, the local configuration on host computer system 102A is checked to determine whether the potentially unsafe application is a known safe application, a known unsafe application or an unknown application in a local configuration indicates application safe/unsafe/unknown operation 208. More particularly, in operation 208, the application characteristic of the potentially unsafe application is used to determine whether the potentially unsafe application is a known safe application, a known unsafe application or an unknown application.

Generally, the application characteristic of the potentially unsafe application includes information about the potentially unsafe application that allows a determination to be made about whether the potentially unsafe application is a known safe application, a known unsafe application or an unknown application. In one particular embodiment, the application characteristic of the potentially unsafe application includes: (1) the hash key of the potentially unsafe application generated in hash application operation 207; and (2) an indicator that indicates what the potentially malicious action of the potentially unsafe application was. As an example, the indicator indicates that the potentially malicious action was an action to delete a system file. However, in another embodiment, the hash key alone is used as the application characteristic.

By using both the hash key and indicator together, i.e., the application characteristic in accordance with one embodiment, a determination is made as to whether the potentially unsafe application is a known safe application, a known unsafe application or an unknown application to host computer system 102A.

To illustrate, assume still that the potentially malicious action of the potentially unsafe application was to delete a system file. By analyzing the hash key of the potentially unsafe application, a determination is made that the potentially unsafe application was authorized to delete a system file. Accordingly, a determination is made that the potentially unsafe application is a known safe application.

Conversely, if the analysis of the hash key of the potentially unsafe application results in a determination that the potentially unsafe application was not authorized to delete a system file, or if the hash key itself indicates that the application is unsafe, then a determination is made that the potentially unsafe application is a known unsafe application.

Further, if the analysis of the hash key of the potentially unsafe application results in a determination that the authorization of the potentially unsafe application to delete a system file is unknown, or if the hash key itself is unknown, then a determination is made that the potentially unsafe application is an unknown application.

In one embodiment, host computer system 102A includes application characteristics of known safe and known unsafe applications, e.g., in a look up table in memory 114. The application characteristics of known safe and known unsafe applications are sometimes called known safe and known unsafe application characteristics, respectively. Host computer system 102A compares the application characteristic of the potentially unsafe application with the known safe and unsafe application characteristics.

If the application characteristic matches a known-safe application characteristic, a determination is made in operation 208 that the potentially unsafe application is a known safe application. In contrast, if the application characteristic matches a known unsafe application characteristic, a determination is made in operation 208 that the potentially unsafe application is a known unsafe application. If the application characteristic doesn't match either a known safe application characteristic or a known unsafe application characteristic, a determination is made in operation 208 that the potentially unsafe application is an unknown application.

If a determination is made in operation 208 that the potentially unsafe application is a known safe application, then flow moves to a resume application operation 210. In resume application operation 210, the potentially unsafe application, which is now a known safe application, is resumed, i.e., execution of the known safe application is resumed. Flow moves from resume application operation 210 and exits at an exit operation 212. However, in an alternative embodiment, instead of exiting at exit operation 212, flow returns to enter operation 202.

If a determination is made in operation 208 that the potentially unsafe application is a known unsafe application, then flow moves to a terminate application operation 214. In terminate application operation 214, the potentially unsafe application, which is now a known unsafe application, is terminated, i.e., execution of the known unsafe application is terminated. Flow moves from terminate application operation 214, optionally, to a notify host machine user/administrator operation 216.

In operation 216, the user of host computer system 102A and/or the administrator are notified that an unsafe application has been terminated on host computer system 102A. The user and/or administrator can be notified using any one of a number of techniques, e.g., by using a pop up window or by writing to a file.

From operation 216 (or directly from operation 214 when operation 216 is not performed), flow exits at exit operation 212. However, in an alternative embodiment, instead of exiting at exit operation 212, flow returns to enter operation 202.

However, if a determination is made in operation 208 that the potentially unsafe application is neither a known safe application nor a known unsafe application, i.e., is an unknown application, then flow moves to a send application characteristic operation 220. In send application characteristic operation 220, the application characteristic is sent to server system 130. In one embodiment, the indicator of the potentially malicious action and the hash key (or just the hash key) of the potentially unsafe application are sent to server system 130 as the application characteristic in send application characteristic operation 220.

As discussed in further detail below, server system 130 uses the application characteristic to generate a response, sometimes called a first response, that indicates whether the potentially unsafe application is a safe application, an unsafe application, or an unknown application. Server system 130 sends the response to host computer system 102A.

From send application characteristic operation 220, flow moves to a receive response operation 222. In receive response operation 222, the response from server system 130 is received. Because only a hash key/indicator from host computer system 102A and a response from server system 130 are sent, the load on network 124 is minimal.

In one embodiment, host computer system 102A is connected to server system 130 using a secure connection during send application characteristic operation 220 and receive response operation 222. In another embodiment, a determination is made that host computer system 102A, e.g., a portable computer, is temporarily disconnected from server system 130 or is connected using an un-secure connection. In accordance with this embodiment, the unsafe application is terminated or send application characteristic operation 220 and receive response operation 222 are suspended until a secure connection to server system 130 is re-established.

Flow moves from receive response operation 222 to a response indicates application safe/unsafe/unknown operation 224. In response indicates application safe/unsafe/unknown operation 224, a determination is made as to whether the response indicates that the potentially unsafe application is a safe application, an unsafe application, or an unknown application. If a determination is made that the potentially unsafe application is an unsafe application in operation 224, flow moves to terminate application operation 214. Operation 214 and, optionally, operation 216 are performed such that the potentially unsafe application, which is now a known unsafe application, is terminated and, optionally, the user and/or administrator are notified as discussed above.

In accordance with this embodiment, flow moves from operation 216 (or directly from operation 214) to an update local configuration operation 226. In update local configuration operation 226, the local configuration, e.g., application characteristics, on host computer system 102A is updated to reflect that the potentially unsafe application is now a known unsafe application. As discussed above, the local configuration is used in local configuration indicates application safe/unsafe/unknown operation 208. Flow moves from update local configuration operation 226 and exits at exit operation 212. However, in an alternative embodiment, instead of exiting at exit operation 212, flow returns to enter operation 202. In yet another embodiment, update local configuration operation 226 is performed before resume application operation 228, i.e., the order of operations 226 and 228 is reversed.

However, if a determination is made that the potentially unsafe application is a safe application in operation 224, flow moves to resume application operation 228.

In resume application operation 228, the potentially unsafe application, which is now a known safe application, is resumed, i.e., execution of the known safe application is resumed. Flow moves from resume application operation 228 to update local configuration operation 226.

In update local configuration operation 226, the local configuration on host computer system 102A is updated to reflect that the potentially unsafe application is now a known safe application. As discussed above, the local configuration is used in local configuration indicates application safe/unsafe/unknown operation 208. Flow moves from update local configuration operation 226 and exits at exit operation 212. However, in an alternative embodiment, instead of exiting at exit operation 212, flow returns to enter operation 202.

However, if a determination is made that the response indicates that the potentially unsafe application is an unknown application in operation 224, flow moves to a send application to server system operation 230. In send application to server system operation 230, the potentially unsafe application is sent to server system 130, for example, the potentially unsafe application is copied and the copy is sent. In one embodiment, the information in the memory of host computer system 102A and/or registers of processor 108 are also mapped (read) to server system 130. Further, in one embodiment, the user of host computer system 102A is notified that the potentially unsafe application has been suspended and/or asked for permission to send the potentially unsafe application to server system 130.

As discussed in detail below, server system 130 determines whether the potentially unsafe application is a safe application or an unsafe application. Based upon this determination, server system 130 generates a response, sometimes called a second response, that indicates whether the application is a safe application or an unsafe application and sends this response to host computer system 102A.

From send application to server system operation 230, flow moves to receive response operation 222. The response from server system 130 is received in receive response operation 222. Flow moves from receive response operation 222 to operation 224. If the response indicates that the potentially unsafe application is an unsafe application, then operations 214, 216, 226 and 212 are performed as discussed above. Alternatively, if the response indicates that the potentially unsafe application is a safe application, then operations 228, 226 and 212 are performed as discussed above.

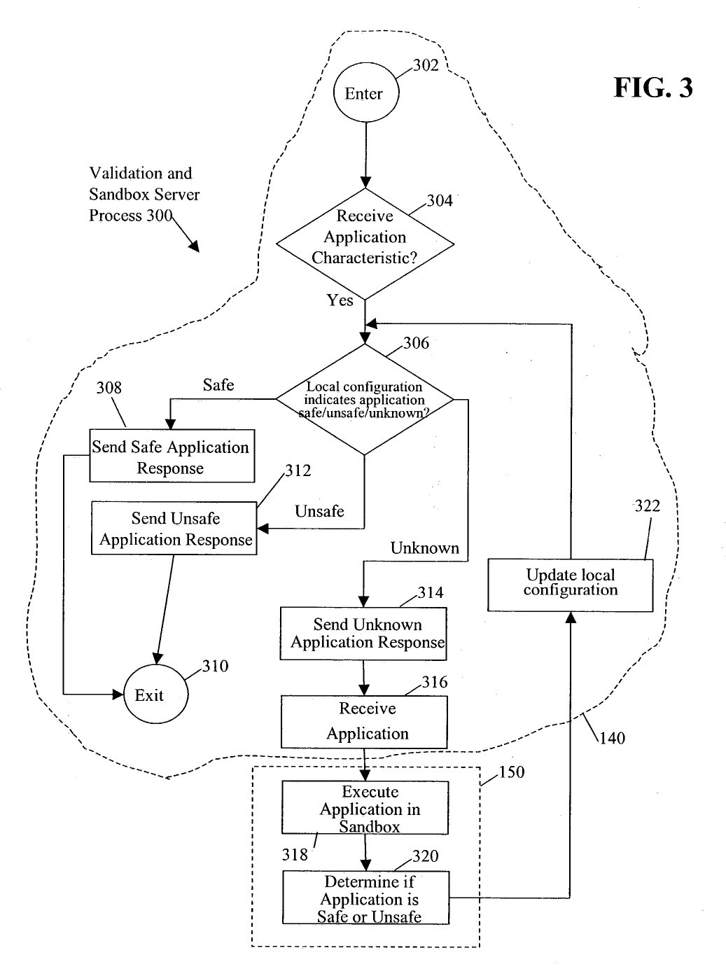

FIG. 3 is a flow diagram of a validation and sandbox server process 300 in accordance with one embodiment of the present invention. For example, referring now to FIGS. 1, 2 and 3 together, execution of validation application 140 and sandbox application 150 by processor 134 results in the operations of validation and sandbox server process 300 as described below.

From an enter operation 302, flow moves to a receive application characteristic operation 304. In receive application characteristic operation 304, a determination is made as to whether an application characteristic, e.g., at least a hash key, has been received by server system 300. As discussed above, an application characteristic is sent from host computer system 102A in send application characteristic operation 220 of host computer process 200. If an application characteristic has not been received, then flow remains at receive application characteristic operation 304.

However, if a determination is made in receive application characteristic operation 304 that an application characteristic has been received, flow moves to a local configuration indicates application safe/unsafe/unknown operation 306. In operation 306, a determination is made as to whether that the application characteristic indicates a known safe application, a known unsafe application, or an unknown application.

In one embodiment, server system 130 includes application characteristics of known safe and known unsafe applications, e.g., in a look up table in memory 136. Server system 130 compares the application characteristic from host computer system 102A with the known safe and unsafe application characteristics. Because server system 130 interacts with many host computer systems, e.g., host computer systems 102B, 102C, . . . , 102n, server system 130 typically includes many more application characteristics of known safe and unsafe applications than host computer system 102A.

In one embodiment, the application characteristics, sometimes called validation configuration, of server system 130 are periodically pushed/distributed, e.g., every hour, by server system 130 to one or more of host computer systems 102A, 102B, 102C, . . . , 102n and/or other server systems to update their local configurations. In another embodiment, the application characteristics of server system 130 are periodically pulled/distributed by one or more of host computer systems 102A, 102B, 102C, . . . , 102n and/or other server systems to update their local configurations.

If the application characteristic matches a known safe application characteristic, a determination is made in operation 306 that the application characteristic indicates a known safe application. In contrast, if the application characteristic matches a known unsafe application characteristic, a determination is made in operation 306 that the application characteristic indicates a known unsafe application. If the application characteristic doesn't match either a known safe application characteristic or a known unsafe application characteristic, a determination is made in operation 306 that the application characteristic indicates an unknown application.

If a determination is made in operation 306 that the application characteristic indicates a known safe application, flow moves to send safe application response operation 308. In send safe application response operation 308, a response indicating that the application is a known safe application is sent from server system 130 to host computer system 102A. As discussed above, this response is received by host computer system 102A in receive response operation 222 of host computer process 200. Flow then moves from send safe application response 308 and exits at an exit operation 310. However, in an alternative embodiment, instead of exiting at exit operation 310, flow returns to enter operation 302.

If a determination is made in operation 306 that the application characteristic indicates a known unsafe application, flow moves to send unsafe application response operation 312. In send unsafe application response operation 312, a response indicating that the application is a known unsafe application is sent from server system 130 to host computer system 102A. As discussed above, this response is received by host computer system 102A in receive response operation 222 of host computer process 200. Flow then moves from send unsafe application response 312 and exits at an exit operation 310. However, in an alternative embodiment, instead of exiting at exit operation 310, flow returns to enter operation 302.

If a determination is made in operation 306 that the application characteristic indicates an unknown application, flow moves to a send unknown application response operation 314. In send unknown application response operation 314, a response indicating that the application is an unknown application is sent from server system 130 to host computer system 102A. As discussed above, this response is received by host computer system 102A in receive response operation 222 of host computer process 200.

From send unknown application response operation 314, flow moves to a receive application operation 316. In receive application operation 316, the potentially unsafe application is received by server system 130 from host computer system 102A. As discussed above, the potentially unsafe application is sent by host computer system 102A in send application to server system operation 230 of host computer process 200.

From receive application 316, flow moves to an execute application in sandbox operation 318. In execute application in sandbox operation 318, the potentially unsafe application is executed in a sandbox. The sandbox includes one or more virtual machines for executing the potentially unsafe application and for monitoring the actions of the potentially unsafe application during execution. In one embodiment, the sandbox virtually represents host computer system 102A. For example, the sandbox includes the full operating system of host computer system 102A, not just a subset of the operating system.

From execute application in sandbox operation 318, flow moves to a determine if application is safe or unsafe operation 320. In determine if application is safe or unsafe operation 320, a determination is made as to whether the potentially unsafe application is a safe application or an unsafe application. More particularly, by determining whether the actions of the potentially unsafe application in the sandbox violate a set of defined rules, a determination is made as to whether the potentially unsafe application is a safe application or an unsafe application. Any one a number of sandbox techniques can be used to determine whether the potentially unsafe application is a safe application or an unsafe application and the particular sandbox technique used is not essential to the present invention.

Because the potentially unsafe application is executed in a sandbox on server system 130, server system 130 resources are used to determine if the potentially unsafe application is a safe application or an unsafe application, not resources of host computer system 102A. Thus, resources of host computer system 102A are conserved. This prevents the degradation of the performance of host computer system 102A, which would otherwise be associated with executing the potentially unsafe application in a sandbox on host computer system 102A.

Further, because the potentially unsafe application is executed in the sandbox only after a determination is made in operation 306 that the potentially unsafe application is an unknown application, the number of applications transferred over network 124 and executed in the sandbox is significantly reduced compared to executing all applications in the sandbox. Thus, use of network 124 and resources of server system 130 is minimized.

In addition, because the potentially unsafe application is executed in the sandbox on server system 130, host computer system 102A is protected from being damaged by the potentially unsafe application.

In one embodiment, operations 318 and 320 are associated with sandbox application 150, e.g., result from execution of sandbox application 150. Further, operations 302, 304, 306, 308, 310, 312, 314, 316 and 322 are associated with validation application 140, e.g., result from execution of validation application 140. However, in another embodiment, the operations associated with sandbox application 150 and validation application 140 can be distributed in a different manner.

In one embodiment, instead of a single server system 130, a first server system, sometimes called a validation server, includes validation application 140. A second server system, sometimes called a sandbox server, includes sandbox application 150. The validation server is interposed between host computer system 102A and the sandbox server such that all interactions between the sandbox server and host computer system 102A pass through and are controlled by the validation server.

From determine if application is safe or unsafe operation 320, flow moves to an update local configuration operation 322. In update local configuration operation 322, the local configuration, e.g., application characteristics, on server system 130 is updated to reflect that the potentially unsafe application is now a known safe application or a known unsafe application. As discussed above, the local configuration is used in local configuration indicates application safe/unsafe/unknown operation 306.

Flow moves from update local configuration operation 322 through operation 306 to send safe application response operation 308 or send unsafe application response operation 312 depending upon whether the potentially unsafe application is determined to be a safe application or an unsafe application, respectively, in operation 320. Alternatively, flow moves directly from update local configuration operation 322 to send safe application response operation 308 or send unsafe application response operation 312 depending upon whether the potentially unsafe application is determined to be a safe application or an unsafe application, respectively, in operation 320.

Referring again to FIG. 1, monitoring and detection application 106 and validation application 140/sandbox application 150 are in computer memories 114 and 136, respectively. As used herein, a computer memory refers to a volatile memory, a non-volatile memory, or a combination of the two. Monitoring and detection application 106, validation application 140 and sandbox application 150 are sometimes called applications 106, 140, 150, respectively.

Although applications 106, 140, 150 are referred to as applications, this is illustrative only. Applications 106, 140, 150 should be capable of being called from an application or the operating system. In one embodiment, an application is generally defined to be any executable code, whether compiled or interpreted, e.g., scripts. Moreover, those of skill in the art will understand that when it is said that an application or an operation takes some action, the action is the result of executing one or more instructions by a processor.

While embodiments in accordance with the present invention have been described for a client-server configuration, an embodiment of the present invention may be carried out using any suitable hardware configuration involving a personal computer, a workstation, a portable device, or a network of computer devices. Other network configurations other than client-server configurations, e.g., peer-to-peer, web-based, intranet, internet network configurations, are used in other embodiments.

Herein, a computer program product comprises a medium configured to store or transport computer readable code in accordance with an embodiment of the present invention. Some examples of computer program products are CD-ROM discs, DVDs, ROM cards, floppy discs, magnetic tapes, computer hard drives, servers on a network and signals transmitted over a network representing computer readable code.

As illustrated in FIG. 1, this medium may belong to the computer system itself. However, the medium also may be removed from the computer system. For example, monitoring and detection application 106 may be stored in memory 136 that is physically located in a location different from processor 108. Processor 108 should be coupled to the memory 136. This could be accomplished in a client-server system, or alternatively via a connection to another computer via modems and analog lines, or digital interfaces and a digital carrier line.

More specifically, in one embodiment, host computer system 102A and/or server system 130 is a portable computer, a workstation, a two-way pager, a cellular telephone, a digital wireless telephone, a personal digital assistant, a server computer, an Internet appliance, or any other device that includes components that can execute the monitoring and detection, validation and sandbox functionality in accordance with at least one of the embodiments-as described herein. Similarly, in another embodiment, host computer system 102A and/or server system 130 is comprised of multiple different computers, wireless devices, cellular telephones, digital telephones, two-way pagers, or personal digital assistants, server computers, or any desired combination of these devices that are interconnected to perform, the methods as described herein.

In another embodiment, load balancing techniques are employed to balance the validation and sandbox functionality across multiple validation and sandbox server systems as those of skill in the art will understand in light of this disclosure.

In view of this disclosure, the monitoring and detection, validation, and sandbox functionality in accordance with one embodiment of present invention can be implemented in a wide variety of computer system configurations. In addition, the monitoring and detection, validation, and sandbox functionality could be stored as different modules in memories of different devices. For example, monitoring and detection application 106 could initially be stored in a server system 130, and then as necessary, a portion of monitoring and detection application 106 could be transferred to host computer system 102A and executed on host computer system 102A. Consequently, part of the monitoring and detection functionality would be executed on processor 134 of server system 130, and another part would be executed on processor 108 of host computer system 102A. In view of this disclosure, those of skill in the art can implement various embodiments of the present invention in a wide-variety of physical hardware configurations using an operating system and computer programming language of interest to the user.

In yet another embodiment, monitoring and detection application 106 is stored in memory 136 of server system 130. Monitoring and detection application 106 is transferred, over network 124 to memory 114 in host computer system 102A. In this embodiment, network interface 138 and I/O interface 110 would include analog modems, digital modems, or a network interface card. If modems are used, network 124 includes a communications network, and monitoring and detection application 106 is downloaded via the communications network.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

What is claimed is:

1. A method comprising:
detecting a potentially malicious action of a potentially unsafe application on a first computer system;
checking a local configuration on said first computer system to determine if said potentially unsafe application is an application unknown to said first computer system, wherein upon a determination that said potentially unsafe application is an application unknown to said first computer system during said checking, said method further comprising:
sending an application characteristic of said potentially unsafe application to a second computer system; and
receiving a first response from said second computer system, said first response indicating whether said potentially unsafe application is a safe application, an unsafe application or an unknown application.

2. The method of claim 1 further comprising suspending said potentially unsafe application subsequent to said detecting.

3. The method of claim 1 wherein said checking a local configuration on said first computer system further comprises determining if said potentially unsafe application is an application known safe or unsafe to said first computer system.

4. The method of claim 3 further comprising suspending said potentially unsafe application subsequent to said detecting, wherein upon a determination that said potentially unsafe application is a known safe application during said checking, said method further comprising resuming said potentially unsafe application.

5. The method of claim 3 wherein upon a determination that said potentially unsafe application is a known unsafe application during said checking, said method further comprising terminating said potentially unsafe application.

6. The method of claim 5 further comprising notifying a user of said first computer system or an administrator that said potentially unsafe application has been terminated.

7. The method of claim 1 wherein said application characteristic is used during said checking.

8. The method of claim 7 further comprising hashing said potentially unsafe application to generate a hash key, said application characteristic comprising said hash key.

9. The method of claim 8 wherein said application characteristic further comprises an indication of said potentially malicious action.

10. The method of claim 1 further comprising suspending said potentially unsafe application subsequent to said detecting, wherein upon said first response indicating that said potentially unsafe application is a safe application, said method further comprising resuming said potentially unsafe application.

11. The method of claim 1 wherein upon said first response indicating that said potentially unsafe application is an unsafe application, said method further comprising terminating said potentially unsafe application.

12. The method of claim 11 further comprising notifying a user of said first computer system or an administrator that said potentially unsafe application has been terminated.

13. The method of claim 1 wherein upon said first response indicating that said potentially unsafe application is an unknown application, said method further comprising:
sending said potentially unsafe application to said second computer system.

14. The method of claim 13 further comprising receiving a second response from said second computer system, said second response indicating whether said potentially unsafe application is a safe application or an unsafe application.

15. The method of claim 14 further comprising suspending said potentially unsafe application subsequent to said detecting, wherein upon said second response indicating that said potentially unsafe application is a safe application, said method further comprising resuming said potentially unsafe application.

16. The method of claim 15 further comprising updating said local configuration.

17. The method of claim 14 wherein upon said second response indicating that said potentially unsafe application is an unsafe application, said method further comprising terminating said potentially unsafe application.

18. The method of claim 17 further comprising updating said local configuration.

19. The method of claim 1 further comprising updating said local configuration of said first computer system by pulling application characteristics of known safe applications and known unsafe applications from said second computer system.

20. The method of claim 1 further comprising updating said local configuration of said first computer system by pushing application characteristics of known safe applications and known unsafe applications to said first computer system.

21. A method comprising:
receiving an application characteristic of a potentially unsafe application; and
using said application characteristic to determine whether said potentially unsafe application is a known safe application, a known unsafe application, or an unknown application.

22. The method of claim 21 wherein upon a determination that said potentially unsafe application is a known safe application during said using, said method further comprising:
sending a safe application response.

23. The method of claim 21 wherein upon a determination that said potentially unsafe application is a known unsafe application during said using, said method further comprising:
sending an unsafe application response.

24. The method of claim 21 wherein upon a determination that said potentially unsafe application is an unknown application during said using, said method further comprising:
sending an unknown application response.

25. The method of claim 24 further comprising:
receiving said potentially unsafe application; and
determining whether said potentially unsafe application is a safe application or an unsafe application.

26. The method of claim 25 wherein upon a determination that said potentially unsafe application is a safe application during said determining, said method further comprising:
sending a safe application response.

27. The method of claim 25 wherein upon a determination that said potentially unsafe application is an unsafe application during said determining, said method further comprising:
sending an unsafe application response.

28. The method of claim 25 further comprising updating a local configuration of a validation server.

29. The method of claim 25 wherein said determining comprises executing said potentially unsafe application in a sandbox.

30. A method comprising:
detecting a potentially malicious action of a potentially unsafe application on a first computer system;
sending an application characteristic of said potentially unsafe application to a second computer system; and
receiving a first response from said second computer system, said first response indicating whether said potentially unsafe application is a safe application, an unsafe application or an unknown application.

31. A computer-program product comprising a computer-readable medium containing computer program code comprising:
a monitoring and detection application for detecting a potentially malicious action of a potentially unsafe application on a first computer system,
said monitoring and detection application further for sending an application characteristic of said potentially unsafe application to a second computer system, and
said monitoring and detection application further for receiving a first response from said second computer system, said first response indicating whether said potentially unsafe application is a safe application, an unsafe application or an unknown application.

32. A computer-program product comprising a computer-readable medium containing computer program code comprising:
a validation application for receiving an application characteristic of a potentially unsafe application, and
said validation application further for using said application characteristic to determine whether said potentially unsafe application is a known safe application, a known unsafe application, or an unknown application.

33. A method comprising:
detecting a potentially malicious action of a potentially unsafe application; and
using a local configuration to determine if said potentially unsafe application is an unknown application.

34. A method comprising:
detecting a potentially malicious action of a potentially unsafe application on a first computer system;
checking a local configuration on said first computer system to determine if said potentially unsafe application is an application unknown to said first computer system, wherein upon a determination that said potentially unsafe application is an application unknown to said first computer system during said checking, said method further comprises:
determining whether a secure connection exists between said first computer and a second computer.

35. The method of claim 34 wherein a determination is made during said determining that said secure connection does not exist, said method further comprising terminating said potentially unsafe application.

36. The method of claim 34 wherein a determination is made during said determining that said secure connection does not exist, said method further comprising suspending said potentially unsafe application until establishment of said secure connection, wherein upon said establishment, said method further comprising:
sending an application characteristic of said potentially unsafe application to said second computer system; and
receiving a first response from said second computer system, said first response indicating whether said potentially unsafe application is a safe application, an unsafe application or an unknown application.
